(19) United States
(12) Patent Application Publication
(10) Pub. No.: US 2025/0346230 A1
(43) Pub. Date: Nov. 13, 2025

(54) ENHANCED ADAPTIVE CRUISE CONTROL

(71) Applicant: Ford Global Technologies, LLC, Dearborn, MI (US)

(72) Inventors: Brendan Francis Diamond, Grosse Pointe, MI (US); Keith Weston, Canton, MI (US); Jordan Barrett, Milford, MI (US); Andrew Denis Lewandowski, Sterling Heights, MI (US)

(73) Assignee: Ford Global Technologies, LLC, Dearborn, MI (US)

(21) Appl. No.: 18/660,400

(22) Filed: May 10, 2024

(51) Int. Cl. B60W 30/16

(52) U.S. Cl. CPC B60W 30/162; B60W 2720/106

(57) ABSTRACT

A speed variation is determined between a target speed for a vehicle and an actual speed of the vehicle. An optimized acceleration and a standard acceleration are determined based on the speed variation. The optimized acceleration reduces an energy consumption of the vehicle. The standard acceleration corresponds to operating parameters for the vehicle. Upon determining that an acceleration variation between the optimized acceleration and the standard acceleration is less than a threshold, the vehicle is operated based on the optimized acceleration. Upon determining that the acceleration variation between the optimized acceleration and the standard acceleration is greater than or equal to the threshold, the standard acceleration is updated based on an acceleration value. Then, the vehicle is operated based on the updated acceleration.

### BACKGROUND

A vehicle can be equipped with electronic and electro-mechanical components, e.g., computing devices, networks, sensors and controllers, etc. A vehicle computer can acquire data regarding the vehicle's environment and can operate the vehicle or at least some components thereof based on the data. Vehicle sensors can provide data concerning routes to be traveled and objects to be accounted for in the vehicle's environment. For example, in a cruise control or adaptive cruise control feature, a vehicle speed can be set and maintained according to user input and/or based on a speed and/or relative position of a reference vehicle, typically an immediately preceding vehicle.

### BRIEF DESCRIPTION OF THE DRAWINGS

FIG. 1 is a block diagram illustrating an example vehicle control system.

FIG. 2 is a diagram illustrating an example of a host vehicle operating in a lane of a road.

FIG. 3 is an example neural network.

FIG. 4A is a first portion of an example flowchart of an example process for operating a host vehicle.

FIG. 4B is a second portion of the flowchart of FIG. 4A.

### DETAILED DESCRIPTION

A system includes a computer including a processor and a memory, the memory storing instructions executable by the processor to determine a speed variation between a target speed for a vehicle and an actual speed of the vehicle. The instructions further include instructions to determine an optimized acceleration and a standard acceleration based on the speed variation. The optimized acceleration reduces an energy consumption of the vehicle, and the standard acceleration corresponds to operating parameters for the vehicle. The instructions further include instructions to, upon determining that an acceleration variation between the optimized acceleration and the standard acceleration is less than a threshold, operate the vehicle based on the optimized acceleration. The instructions further include instructions to, upon determining that the acceleration variation between the optimized acceleration and the standard acceleration is greater than or equal to the threshold, update the standard acceleration based on an acceleration value. The instructions further include instructions to, then, operate the vehicle based on the updated acceleration.

An operating range of the vehicle may be increased in response to operating the vehicle based on the updated acceleration as compared to operating the vehicle based on the standard acceleration.

An operating range of the vehicle may be increased in response to operating the vehicle based on the optimized acceleration.

The acceleration value may be a predetermined constant value.

The instructions can further include instructions to combine the standard acceleration and the acceleration value.

The instructions can further include instructions to operate the vehicle based additionally on at least one of road characteristics and an operation of a second vehicle.

The instructions can further include instructions to select the acceleration value based on the operating parameters of the vehicle.

The instructions can further include instructions to determine a first estimated energy consumption value corresponding to the updated acceleration and a second estimated energy consumption value corresponding to the standard acceleration. The instructions can further include instructions to, upon determining that an energy variation between the first estimated energy consumption value and the second estimated energy consumption is less than an energy consumption threshold, operate the vehicle based on the standard acceleration.

The instructions can further include instructions to, upon determining that the energy variation between the first estimated energy consumption value and the second estimated energy consumption is greater than or equal to the energy consumption threshold, operate the vehicle based on the updated acceleration.

The instructions can further include instructions to, upon determining that an available energy store of the vehicle is less than an energy threshold, operate the vehicle based on the updated acceleration.

The instructions can further include instructions to, upon determining that an available energy store of the vehicle is greater than or equal to the energy threshold, select the acceleration value based on the operating parameters of the vehicle.

The instructions can further include instructions to determine a first estimated energy consumption value corresponding to the updated acceleration and a second estimated energy consumption value corresponding to the standard acceleration. The instructions can further include instructions to, upon determining that an energy variation between the first estimated energy consumption value and the second estimated energy consumption is less than an energy consumption threshold, operate the vehicle based on the standard acceleration.

The instructions can further include instructions to, upon determining that the energy variation between the first estimated energy consumption value and the second estimated energy consumption is greater than or equal to the energy consumption threshold, operate the vehicle based on the updated acceleration.

A method includes determining a speed variation between a target speed for a vehicle and an actual speed of the vehicle. The method further includes determining an optimized acceleration and a standard acceleration based on the speed variation. The optimized acceleration reduces an energy consumption of the vehicle, and the standard acceleration corresponds to operating parameters for the vehicle. The method further includes, upon determining that an acceleration variation between the optimized acceleration and the standard acceleration is less than a threshold, operating the vehicle based on the optimized acceleration. The method further includes, upon determining that the acceleration variation between the optimized acceleration and the standard acceleration is greater than or equal to the threshold, updating the standard acceleration based on an acceleration value. The method further includes, then, operating the vehicle based on the updated acceleration.

An operating range of the vehicle may be increased in response to operating the vehicle based on the updated acceleration as compared to operating the vehicle based on the standard acceleration.

An operating range of the vehicle may be increased in response to operating the vehicle based on the optimized acceleration.

The acceleration value may be a predetermined constant value.

The method can further include selecting the acceleration value based on the operating parameters of the vehicle.

The method can further include, upon determining that an available energy store of the vehicle is less than an energy threshold, operating the vehicle based on the updated acceleration.

The method can further include operating the vehicle based additionally on at least one of road characteristics and an operation of a second vehicle.

Further disclosed herein is a computing device programmed to execute any of the above method steps. Yet further disclosed herein is a computer program product, including a computer readable medium storing instructions executable by a computer processor, to execute an of the above method steps.

A host vehicle can include an adaptive cruise control system to control a speed of the host vehicle. In an adaptive cruise control system, a vehicle computer can maintain or adjust the speed of the host vehicle based on, e.g., a speed and relative position of a lead vehicle in front of the host vehicle and/or a topography of a road. For example, the vehicle computer can actuate a braking component to reduce the speed of the host vehicle when the lead vehicle decelerates and/or is within a specified distance of the host vehicle, and/or when the host vehicle is entering a curved portion or a downhill portion of the road. As another example, the vehicle computer can actuate a propulsion component to increase the speed of the host vehicle when the lead vehicle accelerates and/or is outside of the specified distance of the host vehicle, and/or when the host vehicle is exiting a curved portion or entering an uphill of the road. However, adjusting the speed of the host vehicle in response to changes in the lead vehicle operation, i.e., acceleration or deceleration of the lead vehicle, and/or road topography can result in a high rate of deceleration and/or a high rate of acceleration, e.g., to increase the host vehicle speed to a pre-set speed, which can decrease an energy consumption efficiency of the host vehicle, which in turn decreases an operating range of the host vehicle.

Advantageously, and as described herein, the vehicle computer can determine energy efficient accelerations for the host vehicle based on operating parameters of the host vehicle. By operating the host vehicle based on energy efficient accelerations, the vehicle computer can operate the host vehicle to enhance energy consumption efficiency of the host vehicle, which in turn can increase the operating range of the host vehicle.

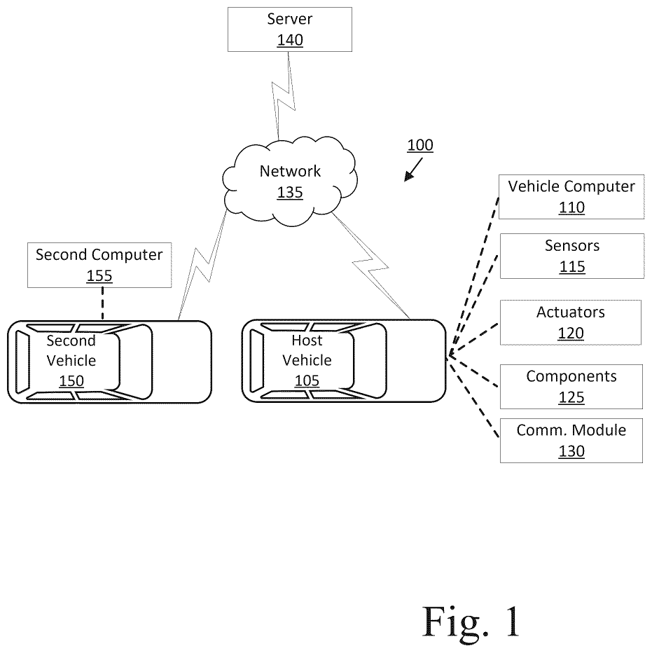

With reference to FIGS. 1-4B, an example vehicle control system 100 includes a host vehicle 105. A vehicle computer 110 in the host vehicle 105 receives data from sensors 115. The vehicle computer 110 is programmed to determine a speed variation between a target speed for the host vehicle 105 and an actual speed of the host vehicle 105. The vehicle computer 110 is further programmed to determine an optimized acceleration and a standard acceleration based on the speed variation. The optimized acceleration reduces an energy consumption of the host vehicle 105. The standard acceleration corresponds to operating parameters for the host vehicle 105. The vehicle computer 110 is further programmed to, upon determining that an acceleration variation between the optimized acceleration and the standard acceleration is less than a threshold, operate the host vehicle 105 based on the optimized acceleration. The vehicle computer 110 is further programmed to, upon determining that the acceleration variation between the optimized acceleration and the standard acceleration is greater than or equal to the threshold, update the standard acceleration based on an acceleration value. The vehicle computer 110 is further programmed to then operate the host vehicle 105 based on the updated acceleration.

Turning now to FIG. 1, the host vehicle 105 includes the vehicle computer 110, sensors 115, actuators 120 to actuate various vehicle components 125, and a vehicle communications module 130. The communications module 130 allows the vehicle computer 110 to communicate with a remote server computer 140, and/or other vehicles, e.g., via a messaging or broadcast protocol such as Dedicated Short Range Communications (DSRC), cellular, and/or other protocol that can support vehicle-to-vehicle, vehicle-to infrastructure, vehicle-to-cloud communications, or the like, and/or via a packet network 135.

The vehicle computer 110 includes a processor and a memory such as are known. The memory includes one or more forms of computer-readable media, and stores instructions executable by the vehicle computer 110 for performing various operations, including as disclosed herein. The vehicle computer 110 can further include two or more computing devices operating in concert to carry out host vehicle 105 operations including as described herein. Further, the vehicle computer 110 can be a generic computer with a processor and memory as described above, and/or may include an electronic control unit (ECU) or electronic controller or the like for a specific function or set of functions, and/or may include a dedicated electronic circuit including an ASIC that is manufactured for a particular operation, e.g., an ASIC for processing sensor data and/or communicating the sensor data. In another example, the vehicle computer 110 may include an FPGA (Field-Programmable Gate Array) which is an integrated circuit manufactured to be configurable by a user. Typically, a hardware description language such as VHDL (Very High Speed Integrated Circuit Hardware Description Language) is used in electronic design automation to describe digital and mixed-signal systems such as FPGA and ASIC. For example, an ASIC is manufactured based on VHDL programming provided pre-manufacturing, whereas logical components inside an FPGA may be configured based on VHDL programming, e.g. stored in a memory electrically connected to the FPGA circuit. In some examples, a combination of processor(s), ASIC(s), and/or FPGA circuits may be included in the vehicle computer 110.

The vehicle computer 110 may operate and/or monitor the host vehicle 105 in an autonomous mode, a semi-autonomous mode, or a non-autonomous (or manual) mode, i.e., can control and/or monitor operation of the host vehicle 105, including controlling and/or monitoring components 125. For purposes of this disclosure, an autonomous mode is defined as one in which each of host vehicle 105 propulsion, braking, and steering are controlled by the vehicle computer 110; in a semi-autonomous mode the vehicle computer 110 controls one or two of host vehicle 105 propulsion, braking, and steering; in a non-autonomous mode a human operator controls each of host vehicle 105 propulsion, braking, and steering.

The vehicle computer 110 may include programming to operate one or more of host vehicle 105 brakes, propulsion (e.g., control of acceleration in the host vehicle 105 by controlling one or more of an internal combustion engine, electric motor, hybrid engine, etc.), steering, transmission, climate control, interior and/or exterior lights, horn, doors, etc., as well as to determine whether and when the vehicle computer 110, as opposed to a human operator, is to control such operations.

The vehicle computer 110 may include or be communicatively coupled to, e.g., via a vehicle communications network such as a communications bus as described further below, more than one processor, e.g., included in electronic controller units (ECUs) or the like included in the host vehicle 105 for monitoring and/or controlling various vehicle components 125, e.g., a transmission controller, a brake controller, a steering controller, etc. The vehicle computer 110 is generally arranged for communications on a vehicle communication network that can include a bus in the host vehicle 105 such as a controller area network (CAN) or the like, and/or other wired and/or wireless mechanisms.

Via the host vehicle 105 network, the vehicle computer 110 may transmit messages to various devices in the host vehicle 105 and/or receive messages (e.g., CAN messages) from the various devices, e.g., sensors 115, an actuator 120, ECUs, etc. Alternatively, or additionally, in cases where the vehicle computer 110 actually comprises a plurality of devices, the vehicle communication network may be used for communications between devices represented as the vehicle computer 110 in this disclosure. Further, as mentioned below, various controllers and/or sensors 115 may provide data to the vehicle computer 110 via the vehicle communication network.

Host vehicle 105 sensors 115 may include a variety of devices such as are known to provide data to the vehicle computer 110. For example, the sensors 115 may include Light Detection And Ranging (LIDAR) sensor(s) 115, etc., disposed on a top of the host vehicle 105, behind a host vehicle 105 front windshield, around the host vehicle 105, etc., that provide relative locations, sizes, and shapes of objects surrounding the host vehicle 105. As another example, one or more radar sensors 115 fixed to host vehicle 105 bumpers may provide data to provide locations of the objects, second vehicles, etc., relative to the location of the host vehicle 105. The sensors 115 may further alternatively or additionally, for example, include camera sensor(s) 115, e.g. front view, side view, etc., providing images from an area surrounding the host vehicle 105. In the context of this disclosure, an object is a physical, i.e., material, item that has mass and that can be represented by physical phenomena (e.g., light or other electromagnetic waves, or sound, etc.) detectable by sensors 115. Thus, the host vehicle 105, as well as other items including as discussed below, fall within the definition of “object” herein.

The vehicle computer 110 is programmed to receive data from one or more sensors 115 substantially continuously, periodically, and/or when instructed by a remote server computer 140, etc. The data may, for example, include a location of the host vehicle 105. Location data specifies a point or points on a ground surface and may be in a known form, e.g., geo-coordinates such as latitude and longitude coordinates obtained via a navigation system, as is known, that uses the Global Positioning System (GPS). Additionally, or alternatively, the data can include a location of an object, e.g., a vehicle, a sign, a tree, etc., relative to the host vehicle 105. As one example, the data may be image data of the environment around the host vehicle 105. In such an example, the image data may include one or more objects and/or markings, e.g., lane markings 305, on or along a road. Image data herein means digital image data, e.g., comprising pixels with intensity and color values, that can be acquired by camera sensors 115. The sensors 115 can be mounted to any suitable location in or on the host vehicle 105, e.g., on a host vehicle 105 bumper, on a host vehicle 105 roof, etc., to collect images of the environment around the host vehicle 105.

The host vehicle 105 actuators 120 are implemented via circuits, chips, or other electronic and or mechanical components that can actuate various vehicle subsystems in accordance with appropriate control signals as is known. The actuators 120 may be used to control components 125, including braking, acceleration, and steering of a host vehicle 105.

In the context of the present disclosure, a vehicle component 125 is one or more hardware components adapted to perform a mechanical or electro-mechanical function or operation—such as moving the host vehicle 105, slowing or stopping the host vehicle 105, steering the host vehicle 105, etc. Non-limiting examples of components 125 include a propulsion component (that includes, e.g., an internal combustion engine and/or an electric motor, etc.), a transmission component, a steering component (e.g., that may include one or more of a steering wheel, a steering rack, etc.), a suspension component (e.g., that may include one or more of a damper, e.g., a shock or a strut, a bushing, a spring, a control arm, a ball joint, a linkage, etc.), a brake component, a park assist component, an adaptive cruise control component, an adaptive steering component, one or more passive restraint systems (e.g., airbags), a movable seat, etc.

In addition, the vehicle computer 110 may be configured for communicating via a vehicle-to-vehicle communication module 130 or interface with devices outside of the host vehicle 105, e.g., through a vehicle-to-vehicle (V2V) or vehicle-to-infrastructure (V2X) wireless communications (cellular and/or short-range radio communications, etc.) to another vehicle, and/or to a remote server computer 140 (typically via direct radio frequency communications). The communications module 130 could include one or more mechanisms, such as a transceiver, by which the computers of vehicles may communicate, including any desired combination of wireless (e.g., cellular, wireless, satellite, microwave and radio frequency) communication mechanisms and any desired network topology (or topologies when a plurality of communication mechanisms are utilized). Exemplary communications provided via the communications module 130 include cellular, Bluetooth, IEEE 802.11, dedicated short range communications (DSRC), cellular V2X (CV2X), and/or wide area networks (WAN), including the Internet, providing data communication services. For convenience, the label “V2X” is used herein for communications that may be vehicle-to-vehicle (V2V) and/or vehicle-to-infrastructure (V2I), and that may be provided by communication module 130 according to any suitable short-range communications mechanism, e.g., DSRC, cellular, or the like.

The network 135 represents one or more mechanisms by which a vehicle computer 110 may communicate with remote computing devices, e.g., the remote server computer 140, another vehicle computer, etc. Accordingly, the network 135 can be one or more of various wired or wireless communication mechanisms, including any desired combination of wired (e.g., cable and fiber) and/or wireless (e.g., cellular, wireless, satellite, microwave, and radio frequency) communication mechanisms and any desired network topology (or topologies when multiple communication mechanisms are utilized). Exemplary communication networks include wireless communication networks (e.g., using Bluetooth®, Bluetooth® Low Energy (BLE), IEEE 802.11, vehicle-to-vehicle (V2V) such as Dedicated Short Range Communications (DSRC), etc.), local area networks (LAN) and/or wide area networks (WAN), including the Internet, providing data communication services.

The remote server computer 140 can be a conventional computing device, i.e., including one or more processors and one or more memories, programmed to provide operations such as disclosed herein. Further, the remote server computer 140 can be accessed via the network 135, e.g., the Internet, a cellular network, and/or or some other wide area network.

A second vehicle 150 may include a second computer 155. The second computer 155 includes a second processor and a second memory such as are known. The second memory includes one or more forms of computer-readable media, and stores instructions executable by the second computer 155 for performing various operations, including as disclosed herein.

Additionally, the second vehicle 150 may include sensors, actuators to actuate various vehicle components, and a vehicle communications module. The sensors, actuators to actuate various vehicle components, and the vehicle communications module typically have features in common with the sensors 115, actuators 120 to actuate various host vehicle components 125, and the vehicle communications module 130, and therefore will not be described further to avoid redundancy.

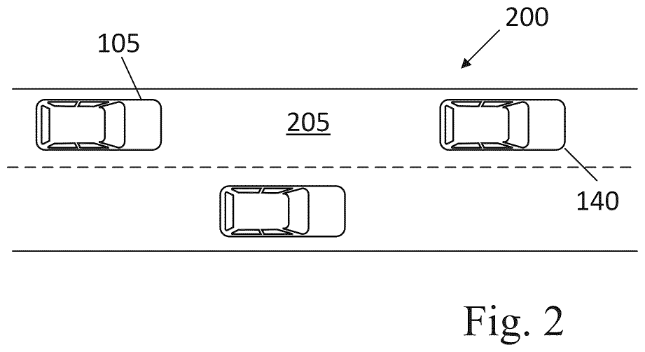

FIG. 2 is a diagram illustrating a host vehicle 105 operating in a host lane 205 of an example road 200. A lane is a specified area of the road for vehicle travel. A road in the present context is an area of ground surface that includes any surface provided for land vehicle travel. A lane of a road is an area defined along a length of a road, typically having a width to accommodate only one vehicle, i.e., such that multiple vehicles can travel in a lane one in front of the other, but not abreast of, i.e., laterally adjacent, one another.

The vehicle computer 110 may be programmed to transition a cruise control mode between a disabled state and an enabled state based on receiving a user input selecting the cruise control mode, e.g., via a human-machine interface (HMI) such as knobs, buttons, switches, pedals, levers, touchscreens, and/or microphones, etc. Upon enabling the cruise control mode, the vehicle computer 110 is programmed to compare an actual vehicle speed, i.e., a speed in a direction along the length of a lane, to a target vehicle speed, i.e., a pre-set speed for operation of the host vehicle 105. For example, the vehicle computer 110 can determine the longitudinal speed of the host vehicle 105 based on sensor 115 data, such as wheel speed sensor 115 data. The target vehicle speed may be specified based on a user input received, e.g., via the HMI, after the vehicle computer 110 transitions the cruise control mode to the enabled state.

When the cruise control mode is enabled, the vehicle computer 110 can determine operating parameters for the host vehicle 105. An operating parameter herein is a physical limit of host vehicle 105 operation, i.e., an operating parameter specifies a limit of a measurement of vehicle operation and/or a measurement of an environmental condition limiting host vehicle 105 operation. Put another way, an operating parameter is a limit of a measurement of a physical characteristic of a host vehicle 105 or an environment around that host vehicle 105 while the vehicle computer 110 is operating the host vehicle 105 in the cruise control mode. A variety of operating parameters may be determined for vehicle operation in the cruise control mode. A non-limiting list of operating parameters includes a speed of the host vehicle 105, an operating distance, an acceleration rate of the host vehicle 105, a position of the host vehicle 105 within a road 200 and/or lane 205, a planned path of the host vehicle 105, road characteristics, a mass of the host vehicle 105, etc.

The vehicle computer 110 is programmed to operate the host vehicle 105 at or below the target speed when the cruise control mode is enabled. That is, the vehicle computer 110 adjusts the actual vehicle speed and/or acceleration of the host vehicle 105 based on one or more environmental factors around the host vehicle 105. As one example, the vehicle computer 110 can adjust the actual vehicle speed and/or acceleration of the host vehicle 105 based on a presence or an absence of a second vehicle 150 within an operating distance of the host vehicle 105. The operating distance specifies a minimum distance between the host vehicle 105 and a second vehicle 150 at which the vehicle computer 110 can operate the host vehicle 105. The operating distance may be determined empirically, e.g., based on determining via testing and/or simulation a distance at which the vehicle computer 110 can control the host vehicle 105 to maintain the minimum specified distance from the second vehicle 150 (e.g., based on an actual speed of the host vehicle 105, an actual speed of the second vehicle 150, etc.).

To detect the presence or absence of the second vehicle 150, the vehicle computer 110 can receive sensor 115 data, e.g., image data, of the environment around the host vehicle 105. The image data can include one or more vehicles traveling on the road 200 around the host vehicle 105. For example, object classification or identification techniques, can be used, e.g., in the vehicle computer 110 based on lidar sensor 115, camera sensor 115, etc., data to identify a type of object, e.g., a vehicle, a bicycle, a drone, etc., as well as physical features of objects.

Various techniques such as are known may be used to interpret sensor 115 data and/or to classify objects based on sensor 115 data. For example, camera and/or lidar image data can be provided to a classifier that comprises programming to utilize one or more conventional image classification techniques. For example, the classifier can use a machine learning technique in which data known to represent various objects, is provided to a machine learning program for training the classifier. Once trained, the classifier can accept as input vehicle sensor 115 data, e.g., an image, and then provide as output, for each of one or more respective regions of interest in the image, an identification and/or a classification (i.e., movable or non-movable) of one or more objects or an indication that no object is present in the respective region of interest. Further, a coordinate system (e.g., polar or cartesian) applied to an area proximate to the host vehicle 105 can be used to specify locations and/or areas (e.g., according to the host vehicle 105 coordinate system, translated to global latitude and longitude geo-coordinates, etc.) of objects identified from sensor 115 data. Yet further, the vehicle computer 110 could employ various techniques for fusing (i.e., incorporating into a common coordinate system or frame of reference) data from different sensors 115 and/or types of sensors 115, e.g., lidar, radar, and/or optical camera data.

Additionally, or alternatively, the vehicle computer 110 can adjust the actual speed of the host vehicle 105 to be below the target speed based on one or more road characteristics of the road 200, i.e., physical quantities that describe measurements and/or limitations of the road. For example, road characteristics can include a curvature, an inclination, a speed limit, number of lanes, topography, etc. The vehicle computer 110 can, for example, determine the road characteristics based on the map data.

When the cruise control mode is enabled, the vehicle computer 110 determines a speed variation between the actual speed of the host vehicle 105 and the target speed. The vehicle computer 110 can determine the speed variation via typical mathematical operations, e.g., a ratio, subtraction, etc. Upon determining the speed variation, the vehicle computer 110 compares the speed variation to a speed threshold. The speed threshold specifies a minimum speed variation between the actual speed and the target speed above which energy efficient acceleration can be realized. The speed threshold may be determined empirically, e.g., based on testing that allows for determining speed variations that realize a reduction of energy consumption during energy efficient acceleration. The speed threshold may be stored, e.g., in a memory of the vehicle computer 110. The vehicle computer 110 may store a plurality of speed thresholds. In such an example, each speed threshold may correspond to one or more operating parameters of the host vehicle 105.

Upon determining that the speed variation is less than or equal to the speed threshold, the vehicle computer 110 can operate the host vehicle 105 based on a standard acceleration of the host vehicle 105. That is, the vehicle computer 110 can actuate one or more vehicle components 125 to increase the actual speed of the host vehicle 105 to the target speed at a specified rate of acceleration. The standard acceleration specifies a rate of acceleration for the host vehicle 105 that is suitable, e.g., comfortable, for an operator of the host vehicle 105 given the operating parameters of the host vehicle 105. For example, the standard acceleration may correspond to a typical acceleration rate desired by an operator during manual operation of the host vehicle 105. To determine the standard acceleration, the vehicle computer 110 can access a look-up table, or the like, that associates various standard accelerations with various operating parameters of the host vehicle 105. That is, the vehicle computer 110 can select the standard acceleration from the look-up table based on the operating parameters of the host vehicle 105. The operating parameters used for determining the standard accelerations may be determined empirically, e.g., from simulation and/or testing, and/or based on crowdsourced data. Crowdsourced data means having a plurality of vehicles provide operating parameters independently of one another and then combining (e.g., by averaging and/or using some other statistical measure) the results. The look-up table may be stored, e.g., in a memory of the vehicle computer 110.

The stored standard accelerations can, for example, be determined based on simulation data. For example, the remote server computer 140 can input various operating parameters of the host vehicle 105 into a vehicle dynamics model. The “vehicle dynamics model” is a kinematic model describing vehicle motion that outputs acceleration data for the host vehicle 105 according to various operating parameters. By inputting a virtual vehicle to the vehicle dynamics model, the remote server computer 140 can collect data about acceleration of the virtual vehicle with various operating parameters. That is, the remote server computer 140 can test the virtual vehicle with a plurality of different (simulated and/or actual) operating parameters. In this situation, the remote server computer 140 can determine the standard acceleration for various operating parameters from the collected data. The remote server computer 140 can then generate the look-up table and provide the look-up table to a plurality of vehicles, including the host vehicle 105, e.g., via the network 135.

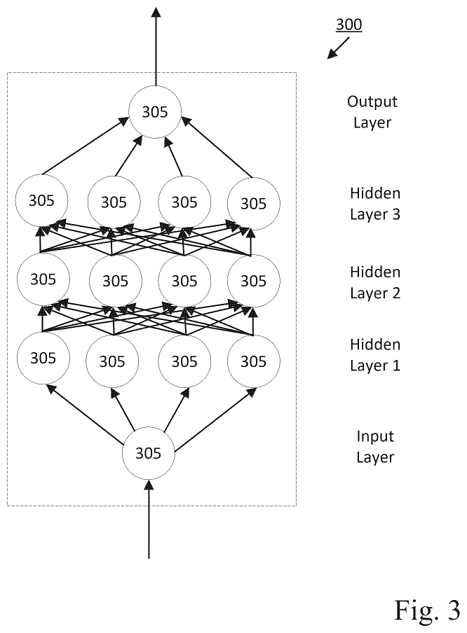

As another example, the remote computer 140 can input the plurality of different (simulated and/or actual) operating parameters into a neural network, such as a deep neural network (DNN) 300 (see FIG. 3), that can be trained to accept operating parameters as input and generate an output of a standard acceleration for the input operating parameters.

Upon determining that the speed variation is greater than the speed threshold, the vehicle computer 110 is programmed to determine an optimized acceleration for the host vehicle 105. The optimized acceleration specifies a rate of acceleration for the host vehicle 105 that reduces an energy consumption of the host vehicle 105. To determine the optimized acceleration, the vehicle computer 110 can access a look-up table, or the like, that associates various optimized accelerations with various operating parameters of the host vehicle 105. That is, the vehicle computer 110 can select the optimized acceleration from the look-up table based on the operating parameters of the host vehicle 105. The look-up table may be stored, e.g., in a memory of the vehicle computer 110. The optimized accelerations stored in the look-up table can be determined based on based on simulation data and/or via output from a neural network, in a manner similar to that discussed above regarding the standard acceleration.

The vehicle computer 110 is programmed to determine an acceleration variation between the optimized acceleration and the standard acceleration. The vehicle computer 110 can determine the acceleration variation via typical mathematical operations, e.g., a ratio, subtraction, etc. Upon determining the acceleration variation, the vehicle computer 110 compares the acceleration variation to a threshold. The threshold specifies a maximum acceleration variation between the optimized acceleration to the standard acceleration below which energy efficient acceleration can be realized. The threshold may be determined empirically, e.g., based on testing that allows for determining a maximum acceleration variation that realizes a reduction of energy consumption during optimized acceleration as compared to during standard acceleration. The threshold may be stored, e.g., in a memory of the vehicle computer 110. The vehicle computer 110 may store a plurality of thresholds. In such an example, each threshold may correspond to one or more operating parameters of the host vehicle 105.

Upon determining that the acceleration variation is less than the threshold, the vehicle computer 110 is programmed to operate the host vehicle 105 based on the optimized acceleration. That is, the vehicle computer 110 can actuate one or more vehicle components 125 to increase the actual speed of the host vehicle 105 to the target speed at the specified rate of acceleration, e.g., that reduces energy consumption of the host vehicle 105. An operating range of the host vehicle 105 may be increased in response to operating the host vehicle 105 based on optimized acceleration. An operating range herein is a measurement of a distance along a road that a vehicle can operate based on operating parameters of the host vehicle 105.

Upon determining that the acceleration variation is greater than or equal to the threshold, the vehicle computer 110 is programmed to determine an acceleration value. An acceleration value herein is a measurement specifying a rate of acceleration. The acceleration value may specify a positive or negative rate of acceleration. The acceleration value may be stored, e.g., in a memory of the vehicle computer 110.

The vehicle computer 110 may be programmed to determine an updated acceleration based on the standard acceleration and the acceleration value. For example, the vehicle computer 110 may combine, e.g., add, the acceleration value to the standard acceleration to determine the updated acceleration. The updated acceleration specifies a rate of acceleration for the host vehicle 105 that reduces energy consumption of the host vehicle 105 as compared to the standard acceleration. That is, an operating range of the host vehicle 105 may be increased in response to operating the host vehicle 105 based on the updated acceleration as compared to operating the host vehicle 105 based on the standard acceleration. The reduction in energy consumption during operation of the host vehicle 105 based on the optimized acceleration may be greater than the reduction in energy consumption during operation of the host vehicle 105 based on the updated acceleration.

The acceleration value may, for example, be a predetermined constant value. That is, one acceleration value may be stored. In such an example, the acceleration value may be determined empirically, e.g., based on determining an average change in acceleration that increases an operating range of a vehicle.

As another example, the vehicle computer 110 may be programmed to select an acceleration value based on operating parameters of the host vehicle 105. In such an example, the vehicle computer 110 can access a look-up table that associates various acceleration values with various operating parameters of the host vehicle 105. In this situation, the vehicle computer 110 can select the acceleration value that corresponds to the operating parameters of the host vehicle 105. The acceleration values stored in the look-up table can be determined based on simulation data and/or via output from a neural network, in a manner similar to that discussed above regarding the standard acceleration.

Upon selecting the acceleration value, the vehicle computer 110 may be programmed to determine a first estimated energy consumption value and a second estimated energy consumption value. The first estimated energy consumption value is associated with the updated acceleration, and the second estimated energy consumption value is associated with the standard acceleration. For example, the vehicle computer 110 can access a look-up table that associated various estimated energy consumption values with various accelerations. The estimated energy consumption values stored in the look-up table can be determined based on based on simulation data and/or via output from a neural network, in a manner similar to that discussed above regarding the standard acceleration.

The vehicle computer 110 may be programmed to determine an energy variation between the first and second estimated energy consumption values. The vehicle computer 110 can determine the energy variation via typical mathematical operations, e.g., a ratio, subtraction, etc. Upon determining the energy variation, the vehicle computer 110 compares the energy variation to an energy consumption threshold. The energy consumption threshold specifies a minimum energy variation between the first and second estimated energy consumption values above which energy efficient acceleration can be realized. The energy consumption threshold may be determined empirically, e.g., based on testing and/or simulation that allows for determining a maximum energy variation that realizes a reduction of energy consumption during updated acceleration as compared to during standard acceleration. The energy consumption threshold may be stored, e.g., in a memory of the vehicle computer 110. The vehicle computer 110 may store a plurality of energy consumption thresholds. In such an example, each threshold may correspond to one or more operating parameters of the host vehicle 105.

Upon determining that the energy variation is less than the energy consumption threshold, the vehicle computer 110 may be programmed to operate the host vehicle 105 based on the standard acceleration. Upon determining that the energy variation is greater than or equal to the energy consumption threshold, the vehicle computer 110 may be programmed to operate the host vehicle 105 based on the updated acceleration.

Additionally, or alternatively, the vehicle computer 110 may be programmed to select one of the standard acceleration and the updated acceleration based on an available energy store of the host vehicle 105. The vehicle computer 110 may be programmed to determine the available energy store based on the operating parameters of the host vehicle 105, e.g., using known energy consumption rates given the operating parameters of the host vehicle 105. An available energy store herein is a measurement of an amount of energy available to operate the host vehicle 105. In the case that the host vehicle 105 is propelled by an internal combustion engine, an amount of energy is a volume of fluid fuel, e.g., gasoline. In the case that the host vehicle 105 is propelled by an electric engine, an amount of energy is an amount of electric charge spent by the battery. In such an example, the vehicle computer 110 can use known electric discharge conversion rates to equivalent fluid fuel volumes to determine the energy consumption, e.g., 33.7 kWh of electricity=1 gallon of gasoline, etc.

Upon determining that the available energy store of the host vehicle 105 is greater than an energy threshold, the vehicle computer 110 may be programmed to select one of the standard acceleration and the updated acceleration based on operating parameters of the host vehicle 105, as discussed above. Upon determining that the available energy store of the host vehicle 105 is less than or equal to the energy threshold, the vehicle computer 110 may be programmed to operate the host vehicle 105 based on the updated acceleration. The energy threshold specifies a minimum available energy store below which energy efficient acceleration is more desirable than vehicle performance and/or comfort. The energy threshold may be determined based on simulation data and/or via output from a neural network, in a manner similar to that discussed above regarding the standard acceleration.

The vehicle computer 110 may be programmed to operate the host vehicle 105 based additionally on at least one of road characteristics and an operation of the second vehicle 150. As one example, the vehicle computer 110 can be programmed to request operating parameters for the second vehicle 150. For example, the vehicle computer 110 can transmit the request to the second vehicle 150, e.g., via V2V communications. In such an example, upon receiving the operating parameters for the second vehicle 150, the vehicle computer 110 can coordinate acceleration of the host vehicle 105 with the second vehicle 150 to further reduce energy consumption, e.g., by achieving an aerodynamic drafting effect from the second vehicle 150. As another example, the vehicle computer 110 can delay operating the host vehicle 105 based on the determined acceleration based on road characteristics, e.g., specified via map data. In such an example, the vehicle computer 110 may initiate acceleration according to the road 200 topography, e.g., a downhill portion, to further reduce energy consumption, e.g., by achieving acceleration due to gravity while operating on the downhill portion of the road 200. As yet another example, the vehicle computer 110 can delay operating the host vehicle 105 based on the determined acceleration based on traffic data, e.g., detected via sensor 115 data and/or received from the remote server computer 140 and/or other vehicles. Traffic data specifies movement and positions of vehicles relative to each other. In such an example, the vehicle computer 110 may initiate acceleration upon determining that a traffic density, i.e., a number of vehicles per unit distance along a length of a road, reduces a likelihood of braking and subsequent acceleration, e.g., determined empirically based on braking and acceleration rates of a vehicle operating on the road 200 given various traffic densities.

FIG. 3 is a diagram of an example deep neural network (DNN) 300 that can be trained to predict standard and optimized accelerations based on operating parameters for the host vehicle 105. The DNN 300 can be a software program that can be loaded in memory and executed by a processor included in a computer, for example. In an example implementation, the DNN 300 can include, but is not limited to, a convolutional neural network (CNN), R-CNN (Region-based CNN), Fast R-CNN, and Faster R-CNN. The DNN includes multiple nodes, and the nodes are arranged so that the DNN 300 includes an input layer, one or more hidden layers, and an output layer. Each layer of the DNN 300 can include a plurality of nodes 305. While FIG. 3 illustrate three (3) hidden layers, it is understood that the DNN 300 can include additional or fewer hidden layers. The input and output layers may also include more than one (1) node 305.

The nodes 305 are sometimes referred to as artificial neurons 305, because they are designed to emulate biological, e.g., human, neurons. A set of inputs (represented by the arrows) to each neuron 305 are each multiplied by respective weights. The weighted inputs can then be summed in an input function to provide, possibly adjusted by a bias, a net input. The net input can then be provided to an activation function, which in turn provides a connected neuron 305 an output. The activation function can be a variety of suitable functions, typically selected based on empirical analysis. As illustrated by the arrows in FIG. 3, neuron 305 outputs can then be provided for inclusion in a set of inputs to one or more neurons 305 in a next layer.

As one example, the DNN 300 can be trained with ground truth data, i.e., data about a real-world condition or state. For example, the DNN 300 can be trained with ground truth data and/or updated with additional data by a processor of the remote server computer 140. Weights can be initialized by using a Gaussian distribution, for example, and a bias for each node 305 can be set to zero. Training the DNN 300 can include updating weights and biases via suitable techniques such as back-propagation with optimizations. Ground truth data can include, but is not limited to, data specifying objects, e.g., vehicles, etc., within an image or data specifying a physical parameter. For example, the ground truth data may be data representing objects and object labels. In another example, the ground truth data may be data representing an object, e.g., a vehicle, and a relative angle and/or speed of the object, e.g., the vehicle, with respect to another object, e.g., another vehicle, etc.

During operation, the vehicle computer 110 determines operating parameters of the host vehicle 105 (as discussed above) and provides the operating parameters to the DNN 300. The DNN 300 generates a prediction based on the received input. The output is a standard and an optimized acceleration for the host vehicle 105 given the operating parameters.

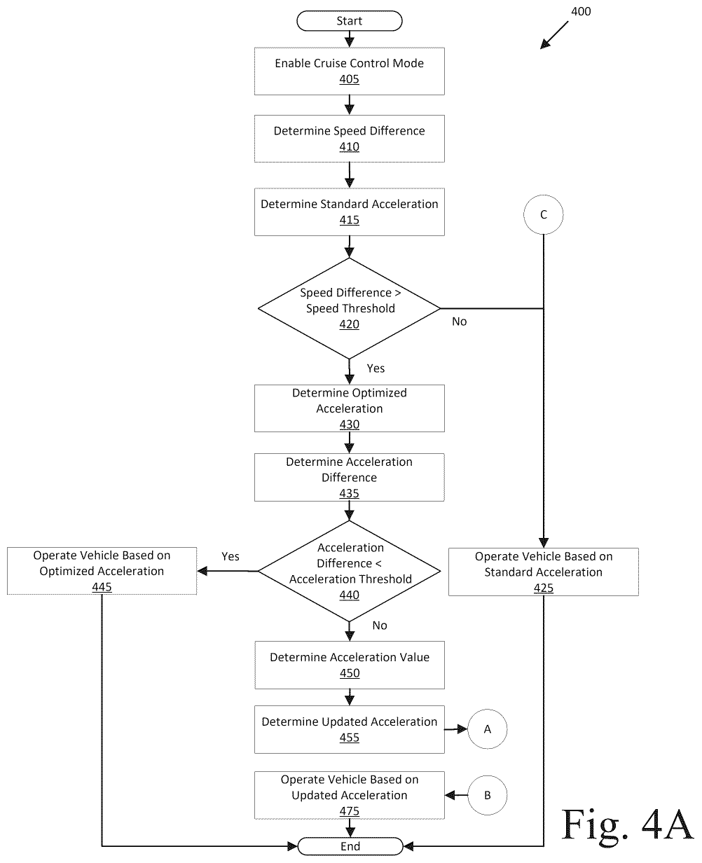

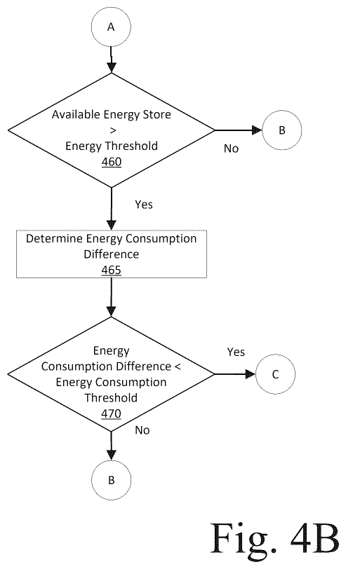

FIG. 4 is a diagram of an example process 400 for operating a host vehicle 105. The process 400 begins in a block 405. The process 400 can be carried out by a vehicle computer 110 included in the host vehicle 105 executing program instructions stored in a memory thereof.

In the block 405, the vehicle computer 110 enables the cruise control mode, as discussed above. Additionally, the vehicle computer 110 determines a target speed, e.g., via a user input, as discussed above. The process 400 continues in a block 410.

In the block 410, the vehicle computer 110 determines a speed variation between an actual speed of the host vehicle 105 and the target speed, as discussed above. Additionally, the vehicle computer 110 can determine operating parameters of the host vehicle 105, as discussed above. The process 400 continues in a block 415.

In the block 415, the vehicle computer 110 determines a standard acceleration based on the operating parameters of the host vehicle 105. The vehicle computer 110 can determine the standard acceleration by accessing a look-up table, as discussed above. The process 400 continues in a block 420.

In the block 420, the vehicle computer 110 compares the speed variation to a speed threshold. If the speed variation is greater than the speed threshold, then the process 400 continues in a block 430. Otherwise, the process 400 continues in a block 425.

In the block 425, the vehicle computer 110 operates the host vehicle 105 based on a standard acceleration, as discussed above. The vehicle computer 110 may operate the host vehicle 105 based additionally on road characteristics, traffic data, and/or second vehicle 150 operation data, as discussed above. The process 400 ends following the block 425. Alternatively, the process 400 may return to the block 410 while the cruise control mode is enabled.

In the block 430, the vehicle computer 110 determines an optimized acceleration based on the operating parameters of the host vehicle 105. The vehicle computer 110 can determine the optimized acceleration by accessing a look-up table, as discussed above. The process 400 continues in a block 435.

In the block 435, the vehicle computer 110 determines an acceleration variation between the standard acceleration and an optimized acceleration of the host vehicle 105, as discussed above. The process 400 continues in a block 440.

In the block 440, the vehicle computer 110 compares the acceleration variation determined in the block 435 to an acceleration threshold. If the acceleration variation is less than the acceleration threshold, then the process 400 continues in a block 445. Otherwise, the process 400 continues in a block 450.

In the block 445, the vehicle computer 110 operates the host vehicle 105 based on the optimized acceleration, as discussed above. The vehicle computer 110 may operate the host vehicle 105 based additionally on road characteristics, traffic data, and/or second vehicle 150 operation data, as discussed above. The process 400 ends following the block 445. Alternatively, the process 400 may return to the block 410 while the cruise control mode is enabled.

In the block 450, the vehicle computer 110 determines an acceleration value. The acceleration value can be a predetermined constant value, as discussed above. Alternatively, the acceleration value can be determined based on operating parameters of the host vehicle 105, as discussed above. The process 400 continues in a block 455.

In the block 455, the vehicle computer 110 determines an updated acceleration. The vehicle computer 110 can combine the standard acceleration and the acceleration value, as discussed above. The process 400 continues in a block 460.

In the block 460, the vehicle computer 110 can compare an available energy store of the host vehicle 105 to an energy threshold. The vehicle computer 110 can determine the available energy store from operating parameters, as discussed above. If the available energy store is greater than the energy threshold, then the process 400 continues in a block 465. Otherwise, the process 400 continues in the block 475.

In the block 465, the vehicle computer 110 determines an energy variation between a first estimated energy consumption value and a second estimated energy consumption value. The first estimated energy consumption value is associated with the updated acceleration, and the second estimated energy consumption value is associated with the standard acceleration. The vehicle computer 110 can determine the first and second estimated energy consumption values based on simulation data and/or output from a neural network, as discussed above. The process 400 continues in a block 470.

In the block 470, the vehicle computer 110 compares the energy variation determined in the block 465 to an energy consumption threshold. If the energy variation is less than the energy consumption threshold, then the process 400 continues in the block 425. Otherwise, the process 400 continues in the block 475.

In the block 475, the vehicle computer 110 operates the host vehicle 105 based on the updated acceleration. The vehicle computer 110 may operate the host vehicle 105 based additionally on road characteristics, traffic data, and/or second vehicle 150 operation data, as discussed above. The process 400 ends following the block 475. Alternatively, the process 400 may return to the block 410 while the cruise control mode is enabled.

Systems and methods described herein may be modified and/or omitted depending on the context, situation, and applicable rules and regulations. Further, regardless actions that may be taken by a vehicle such as a computer controlling vehicle speed and/or acceleration, users should use good judgement and common sense when operating the vehicle. Operations described herein should always be implemented and/or performed in accordance with the owner manual and safety guidelines.

In general, the computing systems and/or devices described may employ any of a number of computer operating systems, including, but by no means limited to, versions and/or varieties of the Ford Sync® application, AppLink/Smart Device Link middleware, the Microsoft Automotive® operating system, the Microsoft Windows® operating system, the Unix operating system (e.g., the Solaris® operating system distributed by Oracle Corporation of Redwood Shores, California), the AIX UNIX operating system distributed by International Business Machines of Armonk, New York, the Linux operating system, the Mac OSX and iOS operating systems distributed by Apple Inc. of Cupertino, California, the BlackBerry OS distributed by Blackberry, Ltd. of Waterloo, Canada, and the Android operating system developed by Google, Inc. and the Open Handset Alliance, or the QNX® CAR Platform for Infotainment offered by QNX Software Systems. Examples of computing devices include, without limitation, an on-board first computer, a computer workstation, a server, a desktop, notebook, laptop, or handheld computer, or some other computing system and/or device.

Computers and computing devices generally include computer-executable instructions, where the instructions may be executable by one or more computing devices such as those listed above. Computer executable instructions may be compiled or interpreted from computer programs created using a variety of programming languages and/or technologies, including, without limitation, and either alone or in combination, Java™, C, C++, Matlab, Simulink, Stateflow, Visual Basic, Java Script, Perl, HTML, etc. Some of these applications may be compiled and executed on a virtual machine, such as the Java Virtual Machine, the Dalvik virtual machine, or the like. In general, a processor (e.g., a microprocessor) receives instructions, e.g., from a memory, a computer readable medium, etc., and executes these instructions, thereby performing one or more processes, including one or more of the processes described herein. Such instructions and other data may be stored and transmitted using a variety of computer readable media. A file in a computing device is generally a collection of data stored on a computer readable medium, such as a storage medium, a random access memory, etc.

Memory may include a computer-readable medium (also referred to as a processor-readable medium) that includes any non-transitory (e.g., tangible) medium that participates in providing data (e.g., instructions) that may be read by a computer (e.g., by a processor of a computer). Such a medium may take many forms, including, but not limited to, non-volatile media and volatile media. Non-volatile media may include, for example, optical or magnetic disks and other persistent memory. Volatile media may include, for example, dynamic random access memory (DRAM), which typically constitutes a main memory. Such instructions may be transmitted by one or more transmission media, including coaxial cables, copper wire and fiber optics, including the wires that comprise a system bus coupled to a processor of an ECU. Common forms of computer-readable media include, for example, RAM, a PROM, an EPROM, a FLASH-EEPROM, any other memory chip or cartridge, or any other medium from which a computer can read.

Databases, data repositories or other data stores described herein may include various kinds of mechanisms for storing, accessing, and retrieving various kinds of data, including a hierarchical database, a set of files in a file system, an application database in a proprietary format, a relational database management system (RDBMS), etc. Each such data store is generally included within a computing device employing a computer operating system such as one of those mentioned above, and are accessed via a network in any one or more of a variety of manners. A file system may be accessible from a computer operating system, and may include files stored in various formats. An RDBMS generally employs the Structured Query Language (SQL) in addition to a language for creating, storing, editing, and executing stored procedures, such as the PL/SQL language mentioned above.

In some examples, system elements may be implemented as computer-readable instructions (e.g., software) on one or more computing devices (e.g., servers, personal computers, etc.), stored on computer readable media associated therewith (e.g., disks, memories, etc.). A computer program product may comprise such instructions stored on computer readable media for carrying out the functions described herein.

With regard to the media, processes, systems, methods, heuristics, etc. described herein, it should be understood that, although the steps of such processes, etc. have been described as occurring according to a certain ordered sequence, such processes may be practiced with the described steps performed in an order other than the order described herein. It further should be understood that certain steps may be performed simultaneously, that other steps may be added, or that certain steps described herein may be omitted. In other words, the descriptions of processes herein are provided for the purpose of illustrating certain embodiments and should in no way be construed so as to limit the claims.

Accordingly, it is to be understood that the above description is intended to be illustrative and not restrictive. Many embodiments and applications other than the examples provided would be apparent to those of skill in the art upon reading the above description. The scope of the invention should be determined, not with reference to the above description, but should instead be determined with reference to the appended claims, along with the full scope of equivalents to which such claims are entitled. It is anticipated and intended that future developments will occur in the arts discussed herein, and that the disclosed systems and methods will be incorporated into such future embodiments. In sum, it should be understood that the invention is capable of modification and variation and is limited only by the following claims.

All terms used in the claims are intended to be given their plain and ordinary meanings as understood by those skilled in the art unless an explicit indication to the contrary in made herein. In particular, use of the singular articles such as “a,” “the,” “said,” etc. should be read to recite one or more of the indicated elements unless a claim recites an explicit limitation to the contrary.

What is claimed is:

1. A system, comprising a computer including a processor and a memory, the memory storing instructions executable by the processor to:
determine a speed variation between a target speed for a vehicle and an actual speed of the vehicle;
determine an optimized acceleration and a standard acceleration based on the speed variation, wherein the optimized acceleration reduces an energy consumption of the vehicle, and the standard acceleration corresponds to operating parameters for the vehicle;
upon determining that an acceleration variation between the optimized acceleration and the standard acceleration is less than a threshold, operate the vehicle based on the optimized acceleration;
upon determining that the acceleration variation between the optimized acceleration and the standard acceleration is greater than or equal to the threshold, update the standard acceleration based on an acceleration value; and
then, operate the vehicle based on the updated acceleration.

2. The system of claim 1, wherein an operating range of the vehicle is increased in response to operating the vehicle based on the updated acceleration as compared to operating the vehicle based on the standard acceleration.

3. The system of claim 1, wherein an operating range of the vehicle is increased in response to operating the vehicle based on the optimized acceleration.

4. The system of claim 1, wherein the acceleration value is a predetermined constant value.

5. The system of claim 1, wherein the instructions further include instructions to combine the standard acceleration and the acceleration value.

6. The system of claim 1, wherein the instructions further include instructions to operate the vehicle based additionally on at least one of road characteristics and an operation of a second vehicle.

7. The system of claim 1, wherein the instructions further include instructions to select the acceleration value based on the operating parameters of the vehicle.

8. The system of claim 7, wherein the instructions further include instructions to:
determine a first estimated energy consumption value corresponding to the updated acceleration and a second estimated energy consumption value corresponding to the standard acceleration; and
upon determining that an energy variation between the first estimated energy consumption value and the second estimated energy consumption is less than an energy consumption threshold, operate the vehicle based on the standard acceleration.

9. The system of claim 8, wherein the instructions further include instructions to, upon determining that the energy variation between the first estimated energy consumption value and the second estimated energy consumption is greater than or equal to the energy consumption threshold, operate the vehicle based on the updated acceleration.

10. The system of claim 1, wherein the instructions further include instructions to, upon determining that an available energy store of the vehicle is less than an energy threshold, operate the vehicle based on the updated acceleration.

11. The system of claim 10, wherein the instructions further include instructions to, upon determining that an available energy store of the vehicle is greater than or equal to the energy threshold, select the acceleration value based on the operating parameters of the vehicle.

12. The system of claim 11, wherein the instructions further include instructions to:
determine a first estimated energy consumption value corresponding to the updated acceleration and a second estimated energy consumption value corresponding to the standard acceleration; and
upon determining that an energy variation between the first estimated energy consumption value and the second estimated energy consumption is less than an energy consumption threshold, operate the vehicle based on the standard acceleration.

13. The system of claim 12, wherein the instructions further include instructions to, upon determining that the energy variation between the first estimated energy consumption value and the second estimated energy consumption is greater than or equal to the energy consumption threshold, operate the vehicle based on the updated acceleration.

14. A method, comprising:
determining a speed variation between a target speed for a vehicle and an actual speed of the vehicle;
determining an optimized acceleration and a standard acceleration based on the speed variation, wherein the optimized acceleration reduces an energy consumption of the vehicle, and the standard acceleration corresponds to operating parameters for the vehicle;
upon determining that an acceleration variation between the optimized acceleration and the standard acceleration is less than a threshold, operating the vehicle based on the optimized acceleration;
upon determining that the acceleration variation between the optimized acceleration and the standard acceleration is greater than or equal to the threshold, updating the standard acceleration based on an acceleration value; and
then, operating the vehicle based on the updated acceleration.

15. The method of claim 14, wherein an operating range of the vehicle is increased in response to operating the vehicle based on the updated acceleration as compared to operating the vehicle based on the standard acceleration.

16. The method of claim 14, wherein an operating range of the vehicle is increased in response to operating the vehicle based on the optimized acceleration.

17. The method of claim 14, wherein the acceleration value is a predetermined constant value.

18. The method of claim 14, further comprising selecting the acceleration value based on the operating parameters of the vehicle.

19. The method of claim 14, further comprising, upon determining that an available energy store of the vehicle is less than an energy threshold, operating the vehicle based on the updated acceleration.

20. The method of claim 14, further comprising operating the vehicle based additionally on at least one of road characteristics and an operation of a second vehicle.
